(19) United States
(12) Patent Application Publication
(10) Pub. No.: US 2019/0329273 A1
(43) Pub. Date: Oct. 31, 2019

(54) ROTARY COATING TOOL

(71) Applicant: Innovative Technology, Inc., Santa Barbara, CA (US)

(72) Inventors: Ralph Tapphorn, Goleta, CA (US); Howard Gabel, Goleta, CA (US)

(21) Appl. No.: 15/965,708

(22) Filed: Apr. 27, 2018

(51) Int. Cl. B05B 3/02; C23C 4/12; B05B 7/14; B05B 7/16; B05B 7/22

(52) U.S. Cl. CPC B05B 3/028; C23C 4/12; B05B 7/168; B05B 7/1626; B05B 7/22; B05B 7/144

(57) ABSTRACT

A rotary coating tool includes a rotary tool for coating bores and surfaces using solid-state deposition and consolidation of high velocity powder particles undergoing thermal plastic deformation.

### INCORPORATION BY REFERENCE

This application incorporates by reference in its entirety and for all purposes the disclosure of U.S. Pat. No. 6,915,964 B2 filed Apr. 5, 2002 and issued Jul. 12, 2005.

### BACKGROUND OF THE INVENTION

### Field of the Invention

The present invention relates to a rotary coating tool. Uses of the tool include coating or additively manufacturing the surface of a part (“part”). The part may be stationary and the rotary tool for coating or additively manufacturing may be rotated around the internal or external surfaces of the part.

Exemplary part surfaces are flat, curved, cylindrical, interior, or exterior surfaces. For example, the part surface may be a cylindrical bore or a cylindrical bore having a particular depth. Part surfaces may take any shape, for example a cylindrical shape that is the interior or exterior of a cylindrical part.

The rotary tool comprises nozzles such as a modified friction compensated sonic nozzle similar to the nozzle disclosed in U.S. Pat. No. 6,915,964. The nozzle may be oriented at an angle with respect to the surface of the part. In various embodiments a preferred angle is perpendicular or normal to the surface of the part that will be coated.

Other embodiments orient the nozzle at acute or obtuse angles with respect to the surface or bore of the part. The rotary tool is for rotation. In an embodiment the tool may be rotated by attachment to a conventional end-effector axis of a robot. In an embodiment the tool may be rotated by a conventional rotation stage such as a conventional rotation stage that is mounted on a linear translation xyz gantry system. The system may permit synchronized rotation and orbital motion of the rotary tool within a bore or internal surface or around a cylinder or external surface of a part.

Parts may be coated using a pattern. For example when coating a part surface the rotary tool may be synchronously translated along the longitudinal axis of the part (i.e., normal to the plane of the rotation and orbital motion) so as to apply the coating in an overlapping helical pattern over the vertical surfaces of the part normal to the plane of rotation and orbital motion.

For parts having a small bore or internal surfaces with small dimensions (e.g., under 4-inches ID for a bore) it may be necessary to adapt a nozzle and elbow to the job. For example, it may be necessary to reduce nozzle and/or elbow length to permit coating or additively manufacturing the part's internal surface.

Embodiments of this invention provide a method of recessing a nozzle deep within a coupling or elbow fitting. Here, the nozzle inlet section may be designed to have a small outer step diameter commensurate with the internal diameter passageway in the coupling or elbow fitting. For example, the nozzle inlet may be seated in close proximity to the elbow outlet so as to minimize the overall length of nozzle and elbow for fitting into small bores or for accessing internal surfaces of the part.

### Discussion of the Related Art

Thermal spray coating of bores is disclosed in U.S. Pat. No. 5,466,906 issued to McCune, Jr. et al. (“McCune”) and in U.S. Pat. No. 5,908,670 issued to Dunkerley et al. (“Dunkerley”). These patents do not disclose rotating the part.

McCune and Dunkerley teach high temperature methods of melting rods and wires to deflect the molten particles at the surface of a bore to form coatings. But, this method has disadvantages including the propensity of the thermal spray methods used to overheat the bore and the part forming the bore.

Further, it is frequently necessary to retract the rotary thermal spray guns used to coat the bores in an attempt to prevent degradation of the part's mechanical properties due to overheating.

A cold spray nozzle for coating areas of small diameter bores is disclosed in U.S. Pat. No. 7,959,093 issued to Payne on Jun. 14, 2011. Payne uses a supersonic cold spray nozzle and process to coat specific areas of small diameter bores. But, Payne does not disclose coating the entire surface of small diameter bores by rotating the cold spray nozzle.

### SUMMARY OF THE INVENTION

This invention provides a tool and a method of using the tool for coating and/or making deposits on parts. Embodiments of this invention may be improvements to U.S. Pat. No. 6,915,964. Embodiments of this invention provide for coating or additively manufacturing a part surface using a rotary tool while the part is stationary.

Part surface(s) are coated/augmented using a rotary tool, for example a rotary tool that rotates a nozzle such as a friction-compensated sonic nozzle. In various embodiments the tool is designed to access a surface, an internal surface, or a bore of a part.

The rotary tool may be attached to and rotated by an i) end-effector joint axis of a robot (“robot”) or a conventional rotation stage mounted on a linear translation xyz gantry system (“gantry”). The rotary tool is moved in synchronized patterns to permit rotation of the nozzle including rotation of the nozzle within tight spaces such as accessing internal part surfaces. The nozzle is maintained at an angle with respect to the part surface, such as normal to the part surface, and the nozzle is manipulated orbitally via the robot or gantry as mentioned above.

Embodiments of the invention permit the rotary tool to be synchronously translated parallel to a longitudinal axis (e.g., normal to the plane of the rotation and orbital motion) of the part surface or bore which i) builds up a coating in an overlapping helical manner or ii) additively manufactures (deposits) a thick coating on the surface or bore of the part.

In an embodiment the rotary tool is fixed to the nozzle via a manifold and the rotary tool is rotated in one direction (e.g., clockwise) through approximately 360 degrees. Afterwards, rotation may be reversed (e.g., counter clockwise) in order to unwind flexible conduits or hoses, such as powder hoses, that connect to the rotary tool.

Alternating rotary tool and manifold nozzle direction of rotation (i.e., clockwise and counter clockwise) enables i) a coating to be built up in an overlapping helical manner or ii) a thick deposit to be additively manufactured on a surface of the part. This material deposition may occur while translating the rotary tool and manifold nozzle along an axis parallel to a longitudinal axis of the surface or bore of the part.

Likewise, the orbital motion of the rotary tool carried by the robot or gantry must be synchronously and alternatively switched from clockwise application to counter clockwise application after approximately 360 degree orbital motion around a circular surface.

Where there is overlap of these 360 degree alternating rotations and orbital motions at a terminal turn-around point, a thicker build-up of the applied material on the part may be expected. In various embodiments, this thicker build up is removed, for example by machining, to achieve proper dimensions. Additional finishing may be required to achieve required dimensional tolerances.

Embodiments of the invention include a small resistive heater. This heater is known as a Thermal Condition Unit (TCU) and is mounted adjacent to the nozzle manifold. The heater heats the gas that is injected into the nozzle manifold. This hot gas mixes with the powder and powder carrier gas before these combined streams reach the nozzle.

The TCU provides a hot gas that thermally softens the powder particles and increases the velocity of the gas flowing through the nozzle. See for example the related discussion in U.S. Pat. No. 6,915,964.

A mounting structure may be used to couple the rotary tool to the robot or gantry. Extending from the TCU, the mounting structure rotates about a central axis of the TCU. This minimizes rotational inertia at high rotational speeds where the TCU mass exceeds or is much greater than the mass of the nozzle manifold with powder injection tube.

Here, the robot or gantry is used to rotate the rotary tool back and forth through 360 degrees. This permits connecting the rotary tool to flexible hose(s) and conduit(s) including one or more of a Powder Fluidizing Unit (“PFU”) hose, a 2nd flexible conduit supplying gas to the TCU, an electrical power to the TCU, and signal wires for reading the temperature of the gas, such as the gas temperature leaving the heater, with a thermocouple. As mentioned, the reversing motion of the rotary tool permits winding and unwinding of hose(s) and conduit(s).

Since the nozzle outlet and nozzle manifold are offset from the rotational axis of the robot or gantry, a synchronous rotation and orbital motion of the rotary tool can be implemented using the robot or gantry to maintain nozzle orientation perpendicular to a surface or bore of the part. Again, the PFU hose and TCU flexible conduit may limit the rotary motion to approximately 360 degrees in one direction (e.g., clockwise) before it becomes necessary to unwind the conduit cable and hose in the opposite direction (e.g., counter clockwise). Here, the robot or gantry must be able to synchronously produce this compound motion of the rotary tool in alternate clockwise and counter clockwise directions (i.e., after approximately 360 degree limits) for both the rotating motion of the rotary tool and the orbital motion of the rotary tool enabled by X-Y translations in a plan view of the part.

For small bores or surfaces of a part with small dimensions (e.g., under 4-inches ID for a bore) it is necessary to shorten the length of the nozzle and elbow to permit coating or additively manufacturing the surface or bore of the part.

A method of recessing a nozzle deep within a coupling or fitting may also be provided. This is accomplished by designing the nozzle inlet to have a small outer step diameter commensurate with the internal diameter of the passageway in the coupling or fitting. For example, the nozzle is coupled to the elbow fitting with a tube adaptor and nut (e.g., Swagelok VCO part# SS-4-VCO-3-4TA and SS-4-VCO-4, respectively). The coupling may employ a metallic C-seal or a temperature compatible O-ring seal of sufficient stiffness and compliance to maintain a gas tight connection at high temperatures. In various embodiments the seal is located between a groove of the tube adapter (e.g., Swagelock VCO part# SS-4-VCO-3-4TA) and the mating seal face of the nozzle. Nozzles may be manufactured using a tungsten carbide cermet.

Since the tungsten carbide cermet has a low coefficient of thermal expansion compared to stainless steel alloys, the compliance of the C-seal or O-ring material must maintain sufficient compression at the seal annular contact interface to insure sealing of the interface over a large temperature range.

Advantages of the invention over prior art include low temperature operation and no need to rotate the part. Low temperature is relative to the melting point of the materials being sprayed, the temperature required being sufficient to melt the powder particles. In particular, low temperature operation of the solid-state impact consolidation process (Kinetic Metallization™) enables continuous coating of bores and internal or external part surfaces without the risk of overheating and consequent thermal degradation of the part. Further, the invention permits a novel method of coating internal surfaces or bores of parts without the need to rotate the part. When compared to using rotary unions and commutators, this invention permits a simplified and economical rotary tool and method of coating bores and internal or external surfaces of parts that avoids rotating heavy or eccentrically weighted parts.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1. is a cross-sectional view of the rotary tool for rotating a nozzle within the internal surface or bore of a part.

FIG. 2. is a plan view showing a combined and synchronized rotation and orbital motion programmed in the robot code for moving the rotary tool to enable coating bores or surfaces of arbitrary diameter or dimensions (i.e., in excess of the length of the friction compensated sonic nozzle with attached elbow).

FIG. 3. is an isometric view showing a modified friction compensated sonic nozzle with stepped outer diameter at the nozzle inlet to permit deep placement within a tube coupling adapter to minimize the overall length of nozzle coupled to elbow fitting.

FIG. 4. is a plan view showing a combined and synchronized rotation and orbital motion programmed in the robot code for moving the rotary tool to enable coating external surfaces or cylindrical shapes of parts or structures using the rotary tool.

### DETAILED DESCRIPTION OF THE PREFERRED EMBODIMENTS

The disclosure provided in the following pages describes examples of some embodiments of the invention. The designs, figures, and description are non-limiting examples of the embodiments they disclose. For example, other embodiments of the disclosed device and/or method may or may not include the features described herein. Moreover, described features, advantages or benefits may apply to only certain embodiments of the invention and should not be used to limit the disclosed invention.

As used herein, the term “coupled” includes direct and indirect connections. Moreover, where first and second devices are coupled, intervening devices including active devices may be located therebetween.

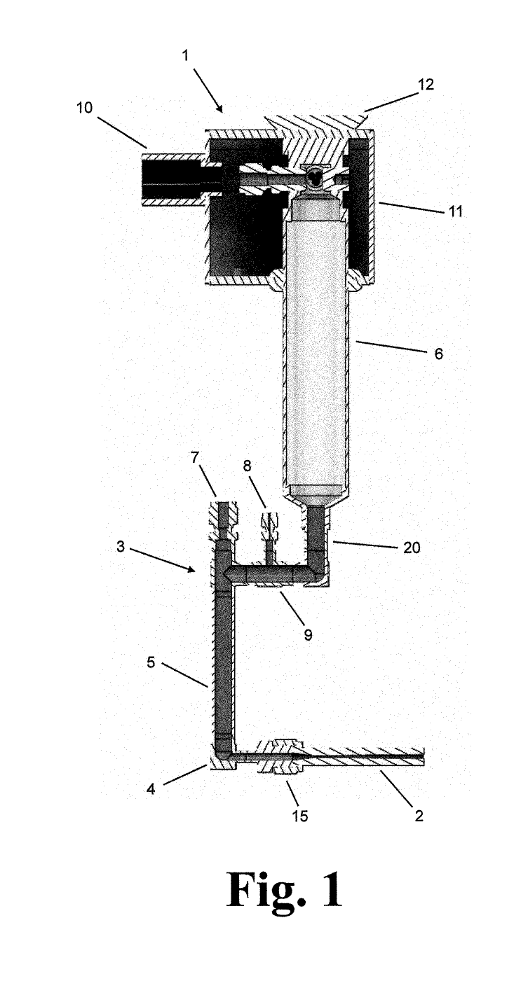

FIG. 1 shows the preferred embodiment of the rotary tool (1) for coating or additively manufacturing the surface of a part. The tool comprises a modified nozzle such as a friction compensated sonic nozzle (2) as disclosed in U.S. Pat. No. 6,915,964. The nozzle is connected to a nozzle manifold (3) via Swagelok VCO fittings ((e.g., Swagelok VCO part# SS-4-VCO-3-4TA and SS-4-VCO-4, respectively) and may include an elbow (4).

The rotary tool (1) includes a gas entry port or connector (10) and a junction box (11) at the head end of a thermal control unit (TCU) or heater (6). Electricity is supplied to the heater via the junction box. This head end may also include a robotic mounting plate or quick disconnect (12) such as a metal plate with a rim or raised rim that is engaged by a robot.

A transition or connector tube (9) connects the heater outlet (20) with a mixing chamber (5). The transition tube includes a thermocouple fitting or well (8) and an entry port or connector (7) for powder and a carrier gas such as a cold gas. An elbow (4) may be used to connect the mixing tube and a nozzle fitting (15) which connects with the nozzle (2).

The inner diameter of the mixing chamber tube (5) is significantly larger than a throat diameter of the friction compensated sonic nozzle (2). As such gas velocities in the mixing chamber tube (5) are lower than those in the nozzle (2). These lower mixing chamber tube velocities are designed to allow time for the hot gas to thermally soften the powder before it enters the nozzle (2).

As mentioned, a thermocouple sensor may be installed to sense temperature of the gas flow using thermocouple port (8). The thermocouple permits the temperature of the mixed TCU and carrier gasses to be measured and controlled to a prescribed set point temperature as may be required for a particular powder.

Powders include aluminum alloy powders for use where the thermocouple set point is about 400 degrees F., Nickel alloys for use where the thermocouple set point is about 1000-1200 degrees F. and Tungsten or Carbon or Tungsten-Carbon alloys where the thermocouple set point is about 1400-1600 degrees. Composite blends of powders may include a matrix material blended with ceramic, carbide, or oxide phase materials that are either metallic or polymer. The rotary gun may be used for coating aluminum alloys and composite blends of aluminum alloys, nickel alloys and composite blends of nickel alloys, tungsten carbide cobalt materials and polymers blended with various ceramic, carbide, and oxide phase materials.

Signals from the thermocouple sensor may be also routed through the junction box (11) to a Programmable Automation Controller via a flexible conduit such as one connected to the flexible conduit port (10). The Programmable Automation Controller controls TCU (6) operation to assure TCU heated gas thermally softens the powder before it enters the nozzle (2). In addition, the Programmable Automation Controller controls gas pressure and powder feed rate at prescribed set point values and maintains stable rotary tool operation.

In an embodiment, the entire rotary tool (1) of FIG. 1 is mounted to a robot or to a gantry via a mounting support structure such as a quick disconnect (12) that is coupled, for example by welding, to the TCU (6) and/or the junction box (11). Rotation of the rotary tool (1) about the central axis of the TCU (6) is accomplished by interconnecting of the TCU with a suitably equipped robot or by gantry.

Methods of (i) rotating the nozzle such as a friction compensated sonic nozzle (2) within a surface or bore, (ii) maintaining the nozzle perpendicular to the surface or bore at all times during rotation and (iii) keeping the friction compensated sonic nozzle outlet at a fixed standoff distance include use of a robot or gantry. For example, a robot or gantry may be used to synchronously rotate the rotary tool and to compensate for offset. In particular, the outlet of the friction compensated sonic nozzle is offset from the rotation axis of the quick release robot mounting support structure (12) and its connected TCU (6). This motion described above may be produced by combining a synchronized rotation and an orbital motion.

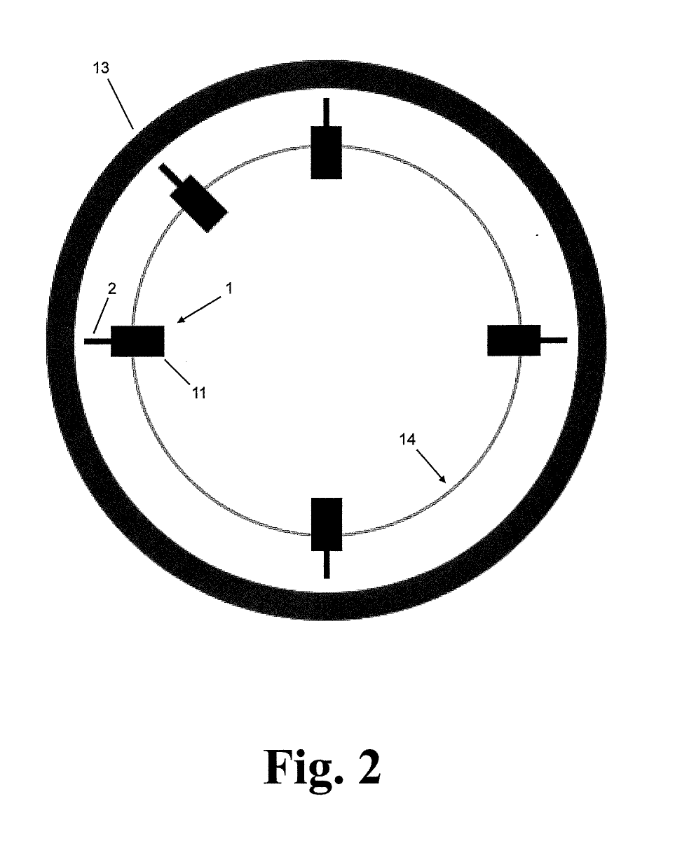

FIG. 2 shows snapshots of a combined and synchronized rotation and orbital motion. In an embodiment this motion produced by a robot executing robot code. As seen in the snapshot motions of the figure, this arrangement permits coating of bores or surfaces of arbitrary diameter or dimensions in excess of the length of the friction compensated sonic nozzle (2) with attached elbow (4).

In like manner, a synchronized rotation and orbital motion of a rotation stage mounted to a linear translation xyz gantry system can be produced. Here, a gantry controller program provides synchronized X-Y motion of the linear translation axis to produce the orbital motion while synchronous tool rotation is via a rotation stage mounted to the gantry using the quick release robot mounting support structure (12).

The snapshots show positions of the friction compensated sonic nozzle (2) oriented perpendicular to the walls of a bore or surface (13) of a part. The rotary tool (1) is rotated synchronously while the rotary tool follows an orbital path (i.e., blue ring circular path (14)) produced by a robot arm such that the nozzle follows the bore or surface (13) contour being coating.

Referring again to FIG. 1, other embodiments of the rotary tool (1) permit the friction compensated sonic nozzle (2) to be connected to elbow (4) at angles other than normal angles to the mixing chamber tube (5). This permits application of coatings to a bore surface or to a surface (13) of a part at beam impingement angles that are oblique or obtuse with respect to a surface normal (i.e., line perpendicular to the surface). This approach allows coating of bores or surfaces (13) of parts with diameters or internal dimensions smaller than those mentioned above.

It is noted that operating the rotary tool (1) with the off-normal configuration may reduce the deposition efficiency of the coating process, but nevertheless allow for coating of smaller bores or surfaces (13) not accommodated by normal angle deposition. Similarly, the friction compensated sonic nozzle (2) can be shortened to lengths that accommodate smaller bores or surfaces (13). Again, a commensurate loss of deposition efficiency may be expected.

To coat or additively manufacture a feature onto a surface of a part, it is necessary to synchronously translate the friction compensated sonic nozzle (2) along a feature length. For example, the nozzle may be translated in a direction parallel to the longitudinal axis of the surface or bore of the part such that depositions overlap in a helical pattern (i.e., similar to X-Y raster overlapping of adjacent strokes). This method of using the nozzle may be used to deposits a continuous layer coating of the powder material on the part.

Robots or gantry systems that use this method must accommodate translation along a feature length while rotating the tool and moving the tool along an orbital path. For example, this motion may be enabled by the robot movements or gantry movements such as gantry linear translation along the z (feature) axis while rotating the tool about an axis perpendicular to the x-y plane and moving the tool along an orbital path in the x-y plane.

Feature length such as the bore depth may require hardware adjustments. For example, the length of the mixing chamber tube (5) can be adjusted to accommodate various part bore depths. In some cases, it may be necessary to thermally insulate the mixing chamber tube (5) to minimize heat loss from the gas and powder mixture prior to passing the gas/power mixture through the nozzle.

In various embodiments, tool rotation requires that interconnecting wires, conduits and hoses be accommodated. For example, it may be necessary to limit rotary tool (1) rotation to approximately 360 degrees after which rotation is reversed to allow unwinding of the interconnecting wires, conduits, and hoses.

This invention also allows for embodiments where rotary unions and commutators are mounted along the central axis of the rotary tool to allow for continuous rotation in one direction (e.g., clockwise) without causing the flexible conduit or hose to wrap around the rotary tool (1). Such rotary union and commutator devices are commonly available for rotary applications involving transmission of gases, fluids, slurries, and electrical signals or power.

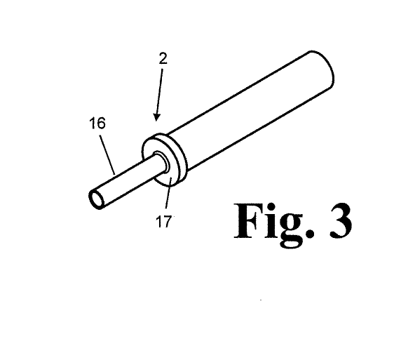

For bores or surface of a part having small dimensions (e.g., under 4-inches ID for a bore), it is may be necessary to shorten the length of the nozzle and elbow to permit coating or additively manufacturing a surface or bore of the part. Referring now to FIG. 3, this invention also discloses a method of recessing the nozzle inlet deep within the coupling fitting (15) as shown in FIG. 1. Here, the nozzle inlet design may provide a small outer step diameter (16) and mating face seal (17) commensurate with the internal diameter passageway in the coupling fitting (15) as shown by FIG. 1.

Further, the friction compensated sonic nozzle (2) and coupling fitting (15) may be connected to the elbow (4) with a tube adaptor and nut (e.g., Swagelok VCO part# SS-4-VCO-3-4TA and SS-4-VCO-4) using a metallic C-seal or high temperature compatible O-ring material with sufficient stiffness and compliance to maintain a tight gas seal at high temperatures between the C-seal or O-ring in contact with the groove of the elbow fitting (e.g, Swagelock VCO part# SS-4-VCO-3-4TA) and the mating seal face of the stepped nozzle, where the nozzle material is typically manufactured using a tungsten carbide cermet.

It is noted that tungsten carbide cermet has a low coefficient of thermal expansion compared to stainless steel alloys and that the compliance of the C-seal or O-ring material must maintain sufficient compression at the seal annular contact interface to insure sealing of the interface over a large temperature range.

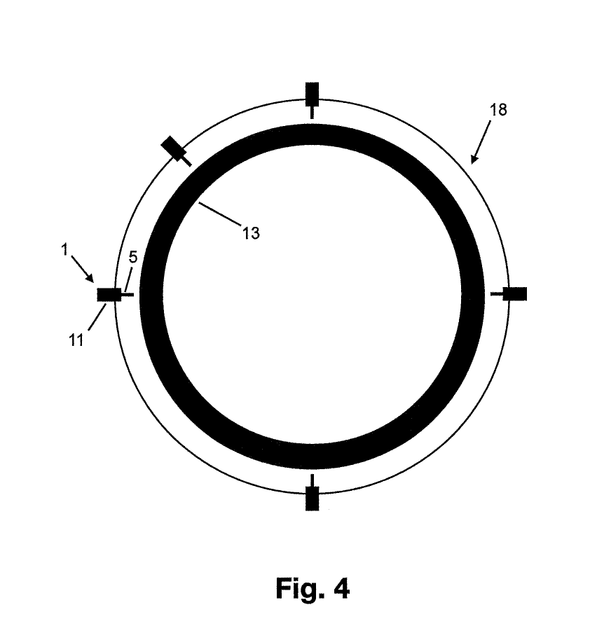

Referring to FIG. 1 and FIG. 4, the rotary tool (1) with friction compensated sonic nozzle (2) can be used to coat or additively manufacture an external part surface by programming the robot arm to follow the outer part surface (i.e., red circular path (18)) while maintaining the friction compensated sonic nozzle (2) normal to the surface being coated.

Synchronous rotation of the rotary tool (1) is shown by the 5 snapshot positions depicted in FIG. 4. As mentioned above, alternating directions (i.e., clockwise and counter clockwise) of rotation and orbital motion allows for wrapping and unwrapping of the flexible conduit and hose about the rotary tool. The external part surface is coated when the robot synchronously translates the rotary tool (1) with friction compensated sonic nozzle (2) in an overlapping helical pattern along the longitudinal axis of the part (i.e., in a direction normal to the plane of the rotation and orbital motion for a cylindrical shaped part).

This rotary tool described herein may also be used for cold spray operations such as cold spray operations using De Laval supersonic nozzles. In addition, improved De Laval supersonic nozzles may be used for cold spray operations. These nozzles include those described in U.S. Pat. No. 5,795,626 by Gabel and in U.S. Pat. No. 7,621,466 by Ko et al.

The embodiments and alternate embodiments mentioned herein may be combined in any fashion. And, various embodiments may include one or more of the described features.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A rotary coating tool comprising:
a nozzle that is a modified friction compensated sonic nozzle is for depositing a thermally softened powder entrained in a carrier gas and a heated gas;
the nozzle for being carried by a mechanism having at least three degrees of freedom for moving the nozzle in an xyz space defined by orthogonal x, y, and z axes;
the nozzle for coating a surface, the nozzle capable of maintaining an orientation such that a nozzle flow direction axis is perpendicular to the surface;
a rotational axis perpendicular to the flow direction axis about which the nozzle can rotate, the rotational axis offset from a centerline of a bore defining the surface;
the mechanism for sweeping the nozzle along a curved line;
the curved line has a beginning and an end, is in an x-y plane that is perpendicular to the centerline, and follows an orbit about the centerline;
the mechanism for rotating the nozzle about the rotational axis; and,
nozzle motion along the z axis for depositing the thermally softened powder on the surface in an overlapping helical pattern.

2. The rotary coating tool of claim 1 wherein when coating a part surface the rotary coating tool is synchronously translated along a longitudinal axis of the part and normal to the plane of the rotation and orbital motion so as to apply the coating in an overlapping helical pattern over the vertical surfaces of the part normal to the plane of rotation and orbital motion.

3. The rotary coating tool of claim 1 wherein a nozzle outlet and a nozzle manifold are offset from the rotational axis and synchronous rotation and orbital motion of the rotary coating tool is implemented using a robot or gantry to maintain nozzle orientation perpendicular to a surface or bore of the part.

4. The rotary coating tool of claim 1 wherein solid-state impact consolidation occurs at a temperature which allows continuous coating of bores while avoiding overheating and part thermal degradation.

5. The rotary coating tool of claim 1 wherein the nozzle is rotated within a bore while maintaining the nozzle perpendicular to the surface or bore and keeping the nozzle outlet at a fixed standoff distance using a robot or gantry.

6. The rotary coating tool of claim 1 further comprising;
a nozzle longitudinal axis different from a mixing chamber longitudinal axis;
wherein the inner diameter of a mixing chamber tube is significantly larger than a throat diameter of the nozzle such that velocities in the mixing chamber tube are lower than those in the nozzle to allow time for the hot gas to thermally soften the powder before it enters the nozzle.

7. The rotary coating tool of claim 1 wherein an initial tool rotation sweeps out an arc of approximately 360 degrees after which rotation is reversed to allow unwinding of the interconnecting wires, conduits, and hoses.

8. The rotary coating tool of claim 1 including a gas connector and an electrical junction box at the head end of a thermal control unit (TCU), a TCU outlet connected to a transition tube that includes a thermowell for a thermocouple and a powder and carrier gas entry connector, the transition tube followed by a mixing chamber, an elbow, and the nozzle, a manifold internal diameter being greater than a nozzle internal diameter by a factor greater than five.
